(19) United States
(12) Patent Application Publication
(10) Pub. No.: US 2025/0121546 A1
(43) Pub. Date: Apr. 17, 2025

(54) INJECTION DEVICE FOR FOAM MOLDING, INJECTION MOLDING MACHINE, AND FOAM MOLDING METHOD

(71) Applicant: The Japan Steel Works, Ltd., Shinagawa-ku , Tokyo (JP)

(72) Inventors: Akihiro NAITO, Shinagawa-ku, TOKYO (JP); Takuya Yufu, Shinagawa-ku, Tokyo (JP)

(21) Appl. No.: 18/707,577

(22) PCT Filed: Sep. 16, 2022
(86) PCT No.: PCT/JP2022/034845

§ 371 Date: May 4, 2024

(30) Foreign Application Priority Data
Nov. 17, 2021 (JP) 2021-186866

(51) Int. Cl. B29C 45/77; B29C 44/34; B29C 44/42; B29C 44/60; B29C 45/00; B29K 105/04

(52) U.S. Cl. CPC B29C 45/77; B29C 44/3446; B29C 44/422; B29C 44/60; B29C 45/0001; B29C 2945/76006; B29C 2945/7619; B29C 2945/76498; B29C 2945/76688; B29K 2105/04

(57) ABSTRACT

An injection device includes a heating cylinder having a gas injection port, a screw, a gas supply device and a control unit. The interior of the heating cylinder is divided into a plasticization zone on an upstream side, a starvation zone on a downstream side of the plasticization zone, and a compression zone on the downstream side of the starvation zone. The gas injection port is provided with an injection valve, and gas is supplied into the heating cylinder in the starvation zone. The heating cylinder includes a pressure sensor. The control unit is configured to control the injection valve based on a resin pressure detected by the pressure sensor.

### TECHNICAL FIELD

The present invention relates to an injection device that injects gas into an injection material to mold a foam molded article, an injection molding machine including such an injection device, and a foam molding method.

### BACKGROUND ART

An injection molding machine that molds a foam molded article using gas such as nitrogen gas or carbon dioxide gas as a physical foaming agent is generally configured as follows, for example, as described in Patent Literature 1. First, an injection device of the injection molding machine includes a heating cylinder and a screw, and the heating cylinder has a plurality of zones according to the shape of the screw. That is, the heating cylinder has a plasticization zone where the resin is plasticized on an upstream side, a starvation zone where a resin pressure decreases on a downstream side of the plasticization zone, and a compression zone where the resin is compressed on the downstream side of the starvation zone. The heating cylinder is provided with a gas injection port corresponding to the starvation zone, so that gas is supplied to the resin and kneaded with the resin.

The resin is melted in the plasticization zone as being fed downstream by the screw in the heating cylinder. Then, the resin pressure is decreased in the starvation zone, and the gas is supplied. The resin supplied with the gas is kneaded and compressed in the compression zone, and metered. When the resin that is kneaded and compressed with the gas is injected into a mold, the gas foams in the mold. That is, a foam molded article is obtained.

### CITATION LIST

### Patent Literature

Patent Literature 1: JP2014-200937A

### SUMMARY OF INVENTION

### Technical Problem

In the injection molding machine for foam molding, the gas is supplied into the resin in the starvation zone. The starvation zone does not necessarily mean that the resin pressure has dropped to an appropriate pressure. This causes a problem that an amount of gas supplied to the resin becomes non-uniform. Further, when the gas is supplied in a state where the resin pressure is high, there is a risk that the resin enters the gas injection port, that is, so-called vent-up occurs. An object of the present disclosure is to stably supply gas into a resin so as to obtain a good foam molded article.

Other problems and novel features will become apparent from description of the present description and the accompanying drawings.

### Solution to Problem

The present inventors have found that the above problem can be solved by providing an injection device having the following configuration. That is, an injection device according to an embodiment of the present invention includes a heating cylinder having a gas injection port, a screw, a gas supply device, and a control unit. The interior of the heating cylinder is divided into a plurality of zones according to the shape of the screw, including a plasticization zone on an upstream side, a starvation zone on a downstream side of the plasticization zone, and a compression zone on the downstream side of the starvation zone. The gas injection port is provided with an injection valve, and gas is supplied into the heating cylinder in the starvation zone. The heating cylinder includes a pressure sensor. The control unit is configured to control the injection valve based on a resin pressure detected by the pressure sensor.

### Advantageous Effects of Invention

According to the present disclosure, it is possible to provide an injection device that can prevent vent-up and properly supply gas into a resin to obtain a non-defective foam molded article, an injection molding machine including the injection device, and a foam molding method.

### BRIEF DESCRIPTION OF DRAWINGS

FIG. 1 is a front view showing an injection molding machine according to the present embodiment.

FIG. 2 is a front sectional view showing an injection device according to the present embodiment.

FIG. 3 is a flowchart showing a metering method which is a part of a foam molding method according to the present embodiment performed in the injection molding machine according to the present embodiment.

FIG. 4 is a front sectional view showing an injection device according to a second embodiment.

FIG. 5A is a front sectional view showing an injection device according to a third embodiment.

FIG. 5B is a front sectional view showing an injection device according to the third embodiment.

FIG. 6 is a front sectional view showing an injection device according to a fourth embodiment.

FIG. 7 is a front sectional view showing an injection device according to a fifth embodiment.

### DESCRIPTION OF EMBODIMENTS

Hereinafter, specific embodiments will be described in detail with reference to the drawings. The present invention is not limited to the following embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

An injection device according to the present embodiment includes:
a heating cylinder having a gas injection port;
a screw provided to be driven in the heating cylinder;
a gas supply device configured to supply gas to the gas injection port; and
a control unit,
in which the heating cylinder is divided into a plurality of zones according to a shape of the screw, including:
   a plasticization zone where a resin is plasticized on an upstream side;
   a starvation zone where a resin pressure decreases on a downstream side of the plasticization zone; and
   a compression zone on the downstream side of the starvation zone,
in which gas from the gas injection port is to be supplied into the heating cylinder in the starvation zone,
in which the gas injection port is provided with an injection valve configured to open and close the gas injection port,
in which the heating cylinder includes a pressure sensor configured to measure a resin pressure, and
in which the control unit is configured to control the injection valve based on the resin pressure detected by the pressure sensor.

An injection molding machine according to the present embodiment includes:
an injection device configured to inject a resin; and
a mold clamp device configured to clamp molds,
in which the injection device includes:
   a heating cylinder having a gas injection port;
   a screw provided to be driven in the heating cylinder;
   a gas supply device configured to supply gas to the gas injection port; and
   a control unit,
in which the heating cylinder is divided into a plurality of zones according to a shape of the screw, including:
   a plasticization zone where a resin is plasticized on an upstream side;
   a starvation zone where a resin pressure decreases on a downstream side of the plasticization zone; and
   a compression zone on the downstream side of the starvation zone,
in which gas from the gas injection port is to be supplied into the heating cylinder in the starvation zone,
in which the gas injection port is provided with an injection valve configured to open and close the gas injection port,
in which the heating cylinder includes a pressure sensor configured to measure a resin pressure, and
in which the control unit is configured to control the injection valve based on the resin pressure detected by the pressure sensor.

A foam molding method according to the present embodiment in which gas is supplied to and kneaded with a resin, and the resin containing the gas is injected to form a foam molded article in an injection device,
the injection device including:
   a heating cylinder having a gas injection port;
   a screw provided to be driven in the heating cylinder; and
   a gas supply device configured to supply gas to the gas injection port;
the heating cylinder being divided into a plurality of zones according to a shape of the screw, including:
   a plasticization zone where a resin is plasticized on an upstream side;
   a starvation zone where a resin pressure decreases on a downstream side of the plasticization zone; and
   a compression zone on the downstream side of the starvation zone,
the gas injection port being provided with an injection valve configured to open and close the gas injection port,
the foam molding method includes:
providing a pressure sensor configured to measure a resin pressure in the heating cylinder; and
when supplying the gas from the gas injection port to the resin in the starvation zone,
   in a case where the resin pressure detected by the pressure sensor exceeds a first threshold value, closing the injection valve; and
   in a case where the resin pressure is equal to or less than the first threshold value, opening the injection valve.

### <Injection Molding Machine>

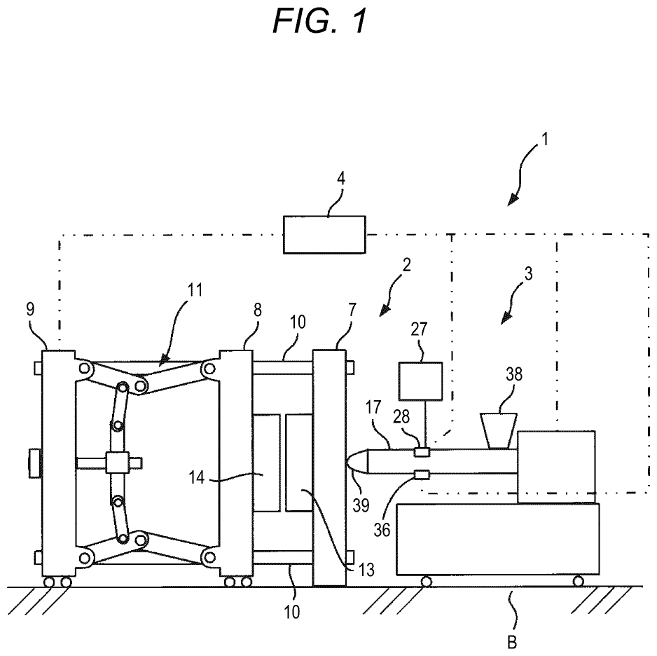

As shown in FIG. 1, an injection molding machine 1 according to the present embodiment roughly includes a mold clamp device 2 and an injection device 3 provided on a bed B, and is controlled by a controller 4, that is, a control unit. The mold clamp device 2 may be of a direct pressure type. In the present embodiment, the mold clamp device 2 is of a toggle type. The mold clamp device 2 includes a fixed platen 7 fixed to the bed B, a movable platen 8 slidably provided on the bed B, and a mold clamp housing 9 also slidably provided on the bed B. The fixed platen 7 and the mold clamp housing 9 are coupled by a plurality of tie bars 10, 10, . . . . The movable platen 8 is disposed between the fixed platen 7 and the mold clamp housing 9, and a toggle mechanism 11 is provided between the movable platen 8 and the mold clamp housing 9.

The fixed platen 7 and the movable platen 8 of the mold clamp device 2 are provided with a fixed mold 13 and a movable mold 14, respectively. When the toggle mechanism 11 is driven, the molds 13 and 14 are clamped. Alternatively, the molds are opened and closed.

### <Injection Device>

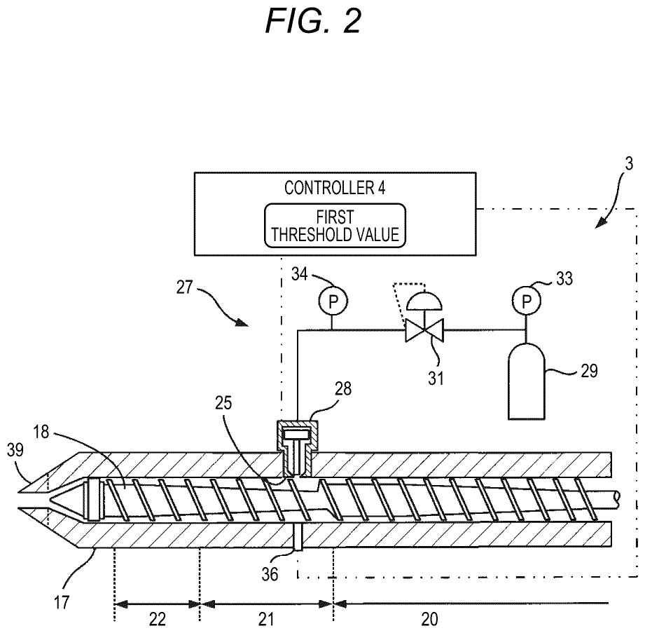

The injection device 3 according to the present embodiment is an injection device for foam molding using a physical foaming agent, that is, a gas such as nitrogen gas or carbon dioxide gas. The injection device 3 is shown in FIG. 2. The injection device 3 includes a heating cylinder 17 and a screw 18 inserted in the heating cylinder 17. The screw 18 has a flight groove depth that changes from an upstream side toward a downstream side, and the interior of the heating cylinder 17 is therefore divided into a plurality of zones. That is, the interior of the heating cylinder 17 is divided into a plasticization zone 20 where a resin is supplied and melted on the upstream side, a starvation zone 21 where a pressure of the melted resin decreases, and a compression zone 22 on the downstream side.

The heating cylinder 17 is provided with a gas injection port 25 through which a gas is supplied. The gas injection port 25 is provided at a position corresponding to the starvation zone 21 when the screw 18 is at a forward position, that is, a screw position at the start of metering. The screw 18 is retracted when the metering process is performed, and the starvation zone 21 is also retracted. In this embodiment, even when the screw 18 reaches a metering completion position, the gas injection port 25 remains in the starvation zone 21. That is, the gas from the gas injection port 25 is normally supplied to the starvation zone 21.

A gas supply device 27 described below is connected to the gas injection port 25, so that gas at a constant pressure is supplied. The injection device 3 according to the present embodiment is characterized in that an injection valve 28 for opening and closing the gas injection port 25 is provided in the gas injection port 25. The injection valve 28 is controlled by the controller 4, and the gas can be efficiently supplied into the resin by appropriately opening and closing the injection valve 28. Further, it is also possible to prevent vent-up in which resin enters the gas injection port. The controller 4 stores a set value used in controlling the injection valve 28, that is, a first threshold value.

### <Gas Supply Device>

The gas supply device 27 includes a gas cylinder 29 that is a gas supply source, and a pressure reducing valve 31 that is configured to reduce the pressure of the gas from the gas cylinder 29 to an appropriate pressure. Although only one gas cylinder 29 is shown in FIG. 2, two or more gas cylinders 29 may be provided, and the gas may be supplied from another gas cylinder 29 when one gas cylinder 29 becomes empty. The gas supply device 27 is provided with a first pressure meter 33 for detecting the pressure of the gas supplied from the gas cylinder 29 and a second pressure meter 34 configured to detect the pressure of the gas reduced by the pressure reducing valve 31.

### <Pressure Sensor>

In the injection device 3 according to the present embodiment, the heating cylinder 17 is provided with a pressure sensor 36. This is also a feature of the present embodiment. The pressure sensor 36 is provided near the gas injection port 25 in the heating cylinder 17. Specifically, when the flight of the screw 18 is considered as a reference, the pressure sensor 36 is provided from the downstream side for one flight round to the upstream side for one flight round around the position where the gas injection port 25 is provided. As described above, the gas injection port 25 is disposed so as to continue to be located in the starvation zone 21 from the start to the completion of the metering. The pressure sensor 36 is also disposed in the starvation zone 21 from the start to the completion of the metering. Accordingly, the pressure sensor 36 continues to detect the resin pressure in the starvation zone 21. The pressure sensor 36 is connected to the controller 4, and the resin pressure is sent to the controller 4.

In the injection device 3 according to the present embodiment, as shown in FIG. 1, a hopper 38 is provided on the upstream side of the heating cylinder 17 to supply resin. An injection nozzle 39 is provided on the downstream side of the heating cylinder 17.

<Foam Molding Method according to Present Embodiment>

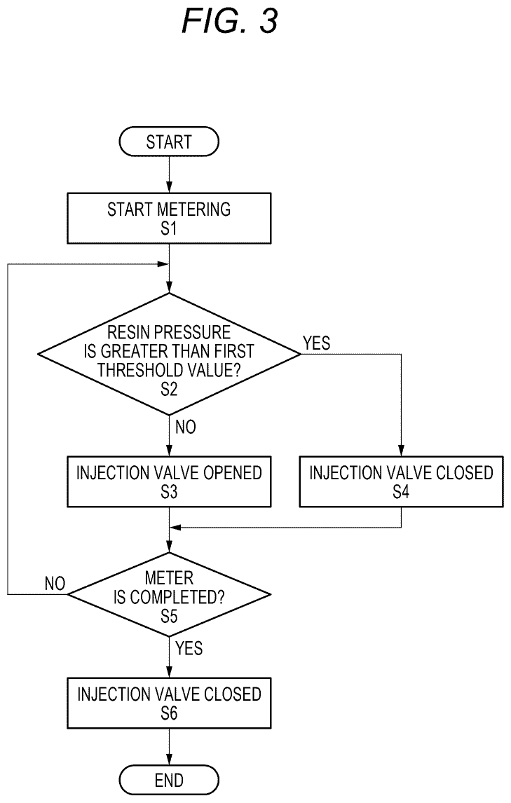

A method of molding a foam molded article by the injection molding machine 1 (see FIG. 1) according to the present embodiment will be described. In the foam molding method for molding a foam molded article, gas is supplied to a resin and kneaded, and the resin containing the gas is metered in the injection device 3; the molds 13 and 14 are clamped in a mold clamp device 2; and the resin containing the gas is injected from the injection device 3. Then, the gas in the resin foams in the molds 13 and 14, and a foam molded article is obtained. The foam molding method according to the present embodiment is characterized by a metering process among such a series of processes. The metering process, which is a part of the foam molding method according to the present embodiment, will be described with reference to FIG. 3.

A state in which a molding cycle is continuously performed will be described. The injection device 3 according to the present embodiment starts the metering process (step S1). That is, the screw 18 is rotated under the command of the controller 4 (see FIG. 2), and the resin is supplied from the hopper 38 (see FIG. 1). At the start of the metering, the injection valve 28 (see FIG. 2) is closed. It is assumed that the screw 18 starts from the forward position, that is, a metering start position in the heating cylinder 17.

Since the molding cycle is continuously performed, the resin in the previous molding cycle remains in the heating cylinder 17. Therefore, along with the start of rotation of the screw 18, the resin is plasticized in the plasticization zone and starts to be fed downstream. The resin in the plasticization zone starts to be sent to the starvation zone 21. The resin in the starvation zone 21 starts to be sent to the compression zone 22. The resin in the compression zone 22 starts to be metered at a tip end of the screw 18. That is, the resin in each of the zones 20, 21, . . . starts to flow to the downstream side as a whole.

When the metering process is started, as shown in FIG. 3, the controller 4 executes step S2. That is, the resin pressure detected by the pressure sensor 36 (see FIG. 2), that is, the resin pressure in the starvation zone 21 is compared with the first threshold value set in the controller 4. If the resin pressure does not exceed the first threshold value, that is, if the resin pressure is equal to or less than the first threshold value, the injection valve 28 is opened (step S3). That is, the gas is supplied to the resin in the starvation zone 21. The resin supplied with the gas Is kneaded in the compression zone 22 (see FIG. 2) and fed to the tip end of the screw 18. That is, the resin is metered. On the other hand, if the resin pressure is greater than the first threshold value, the injection valve 28 is closed (step S4). This makes it possible to prevent the vent-up at the gas injection port 25 (see FIG. 2). Even though the injection valve 28 is closed, the screw 18 continues to rotate and performs the metering.

After executing step S3 or step S4, the controller 4 executes step S5. That is, it is checked whether the screw position of the screw 18 (see FIG. 2) reaches the metering completion position. If the screw position does not reach the metering completion position, the process returns to step S2. That is, the resin pressure detected by the pressure sensor 36 is compared with the first threshold value, and step S3 or step S4 is executed as described above.

In step S5, when the controller 4 determines that the screw position of the screw 18 reaches the metering completion position, step S6 is executed. That is, the injection valve 28 (see FIG. 2) is closed. Then, the supply of the gas into the heating cylinder 17 is stopped. The metering process is completed. As described above, the resin containing the gas is injected into the molds 13 and 14 (see FIG. 1) to mold a foam molded article.

In the metering process of the foam molding method according to the present embodiment, the injection valve 28 is closed when the metering process is completed. That is, the control unit closes the injection valve when the completion of the metering is detected in the injection device. Accordingly, the gas is not unnecessarily supplied into the heating cylinder 17 until the start of the next metering process, and the consumption of the gas can be reduced. However, the injection valve 28 can be maintained in an open state at the completion of the metering process. In this case, the gas can be supplied immediately after the start of metering.

The present embodiment can be variously modified.

For example, as shown in injection devices according to second and third embodiments below, in the injection device according to the embodiments, it is also preferable that a plurality of gas injection ports are provided in the heating cylinder, an injection valve is provided in each of the gas injection ports, and the injection valves are controlled by the control unit.

Further, as shown in injection devices according to second to fifth embodiments below, it is also preferable that the heating cylinder is provided with a plurality of pressure sensors.

<Injection Device according to Second Embodiment>

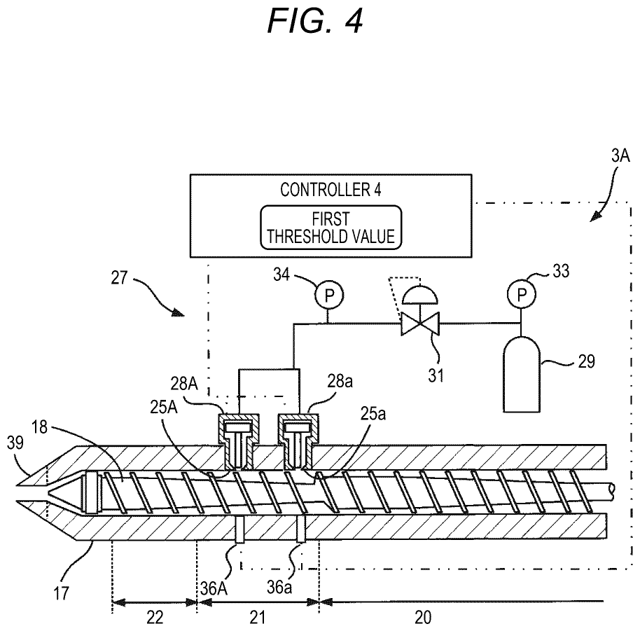

The embodiment can be variously modified, and FIG. 4 shows an injection device 3A according to a second embodiment. In the injection device 3A according to this embodiment, two gas injection ports 25A and 25a are provided in the heating cylinder. That is, a first gas injection port 25A located on the downstream side and a second gas injection port 25a located on the upstream side are provided. The first and second gas injection ports 25A, 25a are both provided so as to be positioned in the starvation zone 21 when the screw 18 is at the metering start position. First and second injection valves 28A and 28a are provided in the first and second gas injection ports 25A and 25a, respectively. The first and second injection valves 28A and 28a are opened and closed by the controller 4. In the injection device 3A according to the second embodiment, two pressure sensors 36A and 36a, that is, first and second pressure sensors 36A and 36a are provided near the first and second gas injection ports 25A and 25a, respectively.

When the metering process is performed by the injection device 3A according to the second embodiment, the first injection valve 28A is controlled to be opened and closed based on the resin pressure detected by the first pressure sensor 36A, and the second injection valve 28a is controlled to be opened and closed based on the resin pressure detected by the second pressure sensor 36a. At the start of the metering, since the first and second gas injection ports 25A, 25a are both located in the starvation zone 21, the gas can be supplied from the first and second gas injection ports 25A, 25a, resulting in high efficiency.

That is, when the screw is located at the screw position at the start of the metering, at least two of the plurality of pressure sensors are preferably located in the starvation zone.

As the metering progresses, when the screw 18 is retracted and the first gas injection port 25A leaves the starvation zone 21, that is, enters the compression zone 22, the resin pressure detected by the first pressure sensor 36A inevitably exceeds the first threshold value. Accordingly, the controller 4 closes the first injection valve 28A. The controller 4 may perform determination based on the screw position of the screw 18, and close the first injection valve 28A without checking the resin pressure.

<Injection Device according to Third Embodiment>

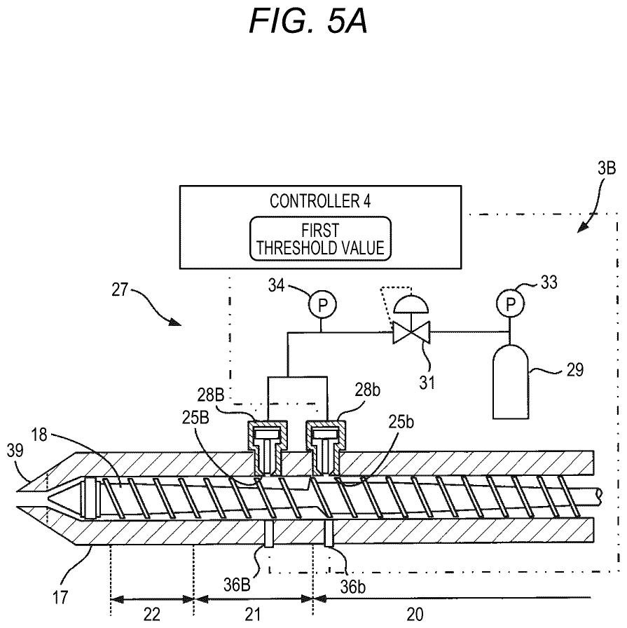

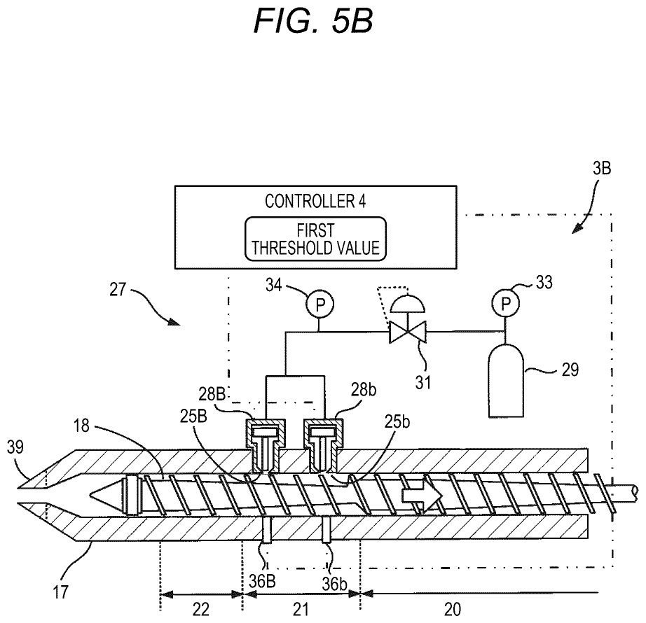

FIG. 5A shows an injection device 3B according to a third embodiment, which is a modification of the injection device 3A according to the second embodiment. Similarly to the injection device 3A (see FIG. 4) according to the second embodiment, the injection device 3B according to the third embodiment also includes first and second gas injection ports 25B and 25b, first and second injection valves 28B and 28b, and first and second pressure sensors 36B and 36b. However, the positions thereof in the heating cylinder 17 are different. That is, when the screw 18 is at the metering start position, the first gas injection valve 25B and the first pressure sensor 36B are located in the starvation zone 21, while the second gas injection valve 25b and the second pressure sensor 36b are located in the plasticization zone 20.

That is, when the screw is located at the screw position at the start of the metering, at least one of the plurality of pressure sensors is preferably located in the starvation zone, and at least one of the plurality of pressure sensors is preferably located in the plasticization zone.

When the metering is started in the injection device 3B according to the third embodiment, only the first gas injection port 25B and the first pressure sensor 36B are located in the starvation zone 21 immediately after the start. Accordingly, only the first gas injection port 25B supplies the gas when the resin pressure becomes equal to or less than the first threshold value. However, when the screw 18 is retreated as the metering progresses, the second gas injection port 25b and the second pressure sensor 36b also enter the starvation zone 21 as shown in FIG. 5B. In this case, the resin pressure becomes equal to or lower than the first threshold value, and the gas can be supplied also from the second gas injection port 25b. As the metering further progresses, the first gas injection port 25B may enter the compression zone 22 and the first injection valve 28B is closed. If a retraction length of the screw 18 during the metering is long or a length of the starvation zone 21 is short, the gas can be stably supplied by providing the plurality of gas injection ports 25B and 25b as described above.

<Injection Device according to Fourth Embodiment>

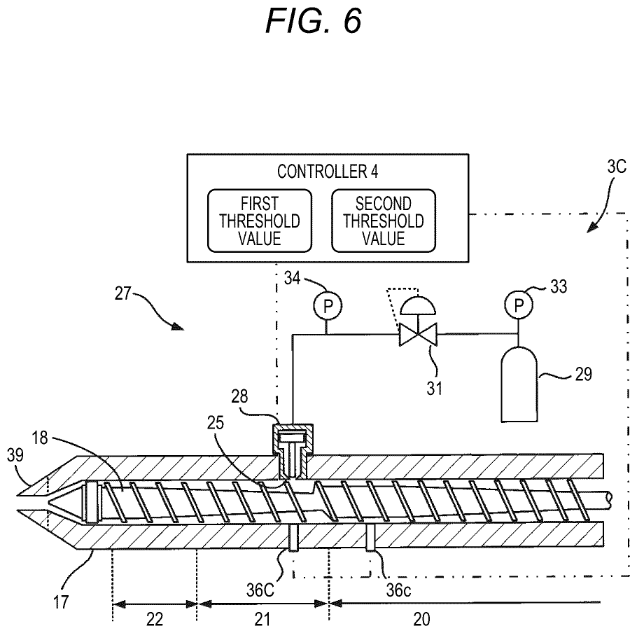

FIG. 6 shows an injection device 3C according to a fourth embodiment. In the injection device 3C according to the fourth embodiment, only one gas injection port 25 is provided in the heating cylinder 17, but two pressure sensors 36C and 36c are provided. That is, first and second pressure sensors 36C and 36c are provided. The first pressure sensor 36C is provided near the gas injection port 25. That is, the first pressure sensor 36C is provided at a position corresponding to the starvation zone 21 when the screw 18 is at the metering start position. On the other hand, the second pressure sensor 36c is provided in the plasticization zone 20.

That is, the injection device according to the fourth embodiment is another example in which, when the screw is at the screw position at the start of the metering, of the plurality of pressure sensors, at least one is located in the starvation zone, and at least one is located in the plasticization zone.

When the metering process is performed in the injection device 3C according to the fourth embodiment, the determination of opening and closing the injection valve 28 can be precisely controlled using not only the resin pressure detected by the first pressure sensor 36C but also the resin pressure detected by the second pressure sensor 36c. During the metering, the resin is sent from the plasticization zone 20 to the starvation zone 21. However, if the resin pressure in the plasticization zone 20 is too high, an amount of the resin sent to the starvation zone 21 increases temporarily, which may cause a phenomenon in which the resin pressure in the starvation zone 21 increases in a short period of time. Therefore, the controller 4 can monitor the resin pressure detected by the second pressure sensor 36c and close the injection valve 28 when the resin pressure exceeds a second threshold value. As a result, the vent-up can be prevented in advance.

<Injection Device according to Fifth Embodiment>

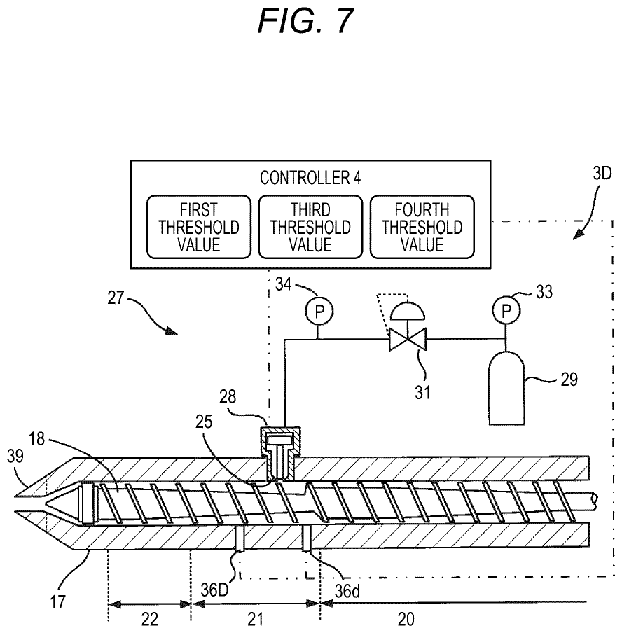

FIG. 7 shows an injection device 3D according to a fifth embodiment. Similarly to the injection device 3C according to the fourth embodiment, the injection device 3D according to this embodiment is also provided with one gas injection port 25 and two pressure sensors 36D and 36d. When the screw 18 is at the metering start position, both the gas injection port 25 and the first and second pressure sensors 36D and 36d are provided in the starvation zone 21. The first pressure sensor 36D is disposed downstream of the gas injection port 25, and the second pressure sensor 36d is disposed upstream of the gas injection port 25.

That is, the injection device according to the fifth embodiment is another example in which at least two of the plurality of pressure sensors are located in the starvation zone when the screw is located at the screw position at the start of the metering. It is also preferable that of the plurality of pressure sensors, at least one is provided upstream of the gas injection port, and at least one is provided downstream of the gas injection port.

When the metering process is performed in the injection device 3D according to the fifth embodiment, control can be performed such that the injection valve 28 is closed when either one of the resin pressures detected by the first and second pressure sensors 36D and 36d exceeds the first threshold value. Further, more advanced control can be performed. For example, the control can be performed such that the injection valve 28 is closed when a rate of increase in the resin pressure detected by the first pressure sensor 36D exceeds a third threshold value or when a rate of increase in the resin pressure detected by the second pressure sensor 36d exceeds a fourth threshold value. This is because when there is a large change in the resin pressure on each of the upstream side and the downstream side of the gas injection port 25, the risk of the vent-up increases.

### <Other Modifications>

Various modifications are possible for the injection device 3 according to the present embodiment. For example, the number of the gas injection ports 25 may be three or more, and the number is not limited. Similarly, the number of the pressure sensors 36 may be three or more, and the number is not limited.

Although the invention made by the present inventors is specifically described based on the embodiments, it is needless to say that the present invention is not limited to the embodiments described above, and various modifications can be made without departing from the scope of the invention. The plurality of examples described above may be appropriately combined.

### INDUSTRIAL APPLICABILITY

According to the present disclosure, it is possible to provide an injection device that can prevent vent-up and properly supply gas into a resin to obtain a non-defective foam molded article, an injection molding machine including the injection device, and a foam molding method.

Although the present invention has been described in detail with reference to specific embodiments, it will be apparent to those skilled in the art that various changes and modifications can be made without departing from the spirit and scope of the present invention. The present application is based on Japanese Patent Application No. 2021-186866 filed on Nov. 17, 2021, and the contents thereof are incorporated herein as reference.

REFERENCE SIGNS LIST

| | | | |
|---|---|---|---|
| 1 | Injection molding machine | 2 | Mold clamp device |
| 3 | Injection device | 4 | Controller |
| 7 | Movable platen | 8 | Fixed platen |
| 9 | Mold clamp housing | 10 | Tie bar |
| 11 | Toggle mechanism | 13 | Fixed mold |
| 14 | Movable mold | 17 | Heating cylinder |
| 18 | Screw | 20 | Plasticization zone |
| 21 | Starvation zone | 22 | Compression zone |
| 25 | Gas injection port | 27 | Gas supply device |
| 28 | Injection valve | 29 | Gas cylinder |
| 31 | Pressure reducing valve | 33 | First pressure meter |
| 34 | Second pressure meter | 36 | Pressure sensor |
| 38 | Hopper | 39 | Injection nozzle |
| B | Bed | | |
| 3A, 3B, 3C, 3D | Injection device | | |
| 25A, 25B | First gas injection port | | |
| 25a, 25b | Second gas injection port | | |
| 28A 28B | First injection valve | | |
| 28a, 28b | Second injection valve | | |
| 36A, 36B, 36C, 36D | First pressure sensor | | |
| 36a, 36b, 36c, 36d | Second pressure sensor | | |

1. An injection device comprising:
a heating cylinder having a gas injection port;
a screw provided to be driven in the heating cylinder;
a gas supply device configured to supply gas to the gas injection port; and
a control device,
wherein the heating cylinder is divided into a plurality of zones according to a shape of the screw, including:
a plasticization zone where a resin is plasticized on an upstream side;
a starvation zone where a resin pressure decreases on a downstream side of the plasticization zone, and
a compression zone on the downstream side of the starvation zone,
wherein gas from the gas injection port is to be supplied into the heating cylinder in the starvation zone,
wherein the gas injection port is provided with an injection valve configured to open and close the gas injection port,
wherein the heating cylinder includes a pressure sensor configured to measure a resin pressure, and
wherein the control device is configured to control the injection valve based on the resin pressure detected by the pressure sensor.

2. The injection device according to claim 1, wherein the heating cylinder has a plurality of the gas injection ports, each of the gas injection ports being provided with the injection valve controlled by the control device.

3. The injection device according to claim 1, wherein the heating cylinder includes a plurality of the pressure sensors.

4. The injection device according to claim 3, wherein in a case where the screw is located at a screw position at the start of metering, at least two of the plurality of pressure sensors are located in the starvation zone.

5. The injection device according to claim 3, wherein in a case where the screw is located at a screw position at the start of metering, at least one of the plurality of pressure sensors is located in the starvation zone, and at least another one of the plurality of pressure sensors is located in the plasticization zone.

6. The injection device according to claim 3, wherein at least one of the plurality of pressure sensors is provided upstream of the gas injection port, and at least another one of the plurality of pressure sensors is provided downstream of the gas injection port.

7. The injection device according to claim 1, wherein the control device is configured to close the injection valve based on detecting completion of metering in the injection device.

8. An injection molding machine comprising:
an injection device configured to inject a resin; and
a mold clamp device configured to clamp molds,
wherein the injection device includes:
a heating cylinder having a gas injection port;
a screw provided to be driven in the heating cylinder;
a gas supply device configured to supply gas to the gas injection port; and
a control device,
wherein the heating cylinder is divided into a plurality of zones according to a shape of the screw, including:
a plasticization zone where a resin is plasticized on an upstream side;
a starvation zone where a resin pressure decreases on a downstream side of the plasticization zone; and
a compression zone on the downstream side of the starvation zone,
wherein gas from the gas injection port is to be supplied into the heating cylinder in the starvation zone,
wherein the gas injection port is provided with an injection valve configured to open and close the gas injection port,
wherein the heating cylinder includes a pressure sensor configured to measure a resin pressure, and
wherein the control device is configured to control the injection valve based on the resin pressure detected by the pressure sensor.

9. The injection molding machine according to claim 8, wherein the heating cylinder has a plurality of the gas injection ports, each of the gas injection ports being provided with the injection valve controlled by the control device.

10. The injection molding machine according to claim 8, wherein the heating cylinder includes a plurality of the pressure sensors.

11. The injection molding machine according to claim 10, wherein in a case where the screw is located at a screw position at the start of metering, at least two of the plurality of pressure sensors are located in the starvation zone.

12. The injection molding machine according to claim 10, wherein in a case where the screw is located at a screw position at the start of metering, at least one of the plurality of pressure sensors is located in the starvation zone, and at least another one of the plurality of pressure sensors is located in the plasticization zone.

13. The injection molding machine according to claim 10, wherein at least one of the plurality of pressure sensors is provided upstream of the gas injection port, and at least another one of the plurality of pressure sensors is provided downstream of the gas injection port.

14. The injection molding machine according to claim 3, wherein the control device is configured to close the injection valve based on detecting completion of metering in the injection device.

15. A foam molding method in which gas is supplied to and kneaded with a resin, and the resin containing the gas is injected to form a foam molded article in an injection device,
the injection device including:
a heating cylinder having a gas injection port;
a screw provided to be driven in the heating cylinder; and
a gas supply device configured to supply gas to the gas injection port,
the heating cylinder being divided into a plurality of zones according to a shape of the screw, including:
a plasticization zone where a resin is plasticized on an upstream side;
a starvation zone where a resin pressure decreases on a downstream side of the plasticization zone; and
a compression zone on the downstream side of the starvation zone,
the gas injection port being provided with an injection valve configured to open and close the gas injection port,
the foam molding method comprising:
providing a pressure sensor configured to measure a resin pressure in the heating cylinder; and
when supplying the gas from the gas injection port to the resin in the starvation zone,
in a case where the resin pressure detected by the pressure sensor exceeds a first threshold value, closing the injection valve; and
in a case where the resin pressure is equal to or less than the first threshold value, opening the injection valve.

16. The foam molding method according to claim 15, comprising closing the injection valve in a case where metering is completed in the injection device.
